(19) United States
(12) Patent Application Publication
(10) Pub. No.: US 2005/0111563 A1
(43) Pub. Date: May 26, 2005

(54) DE-MAPPING METHOD FOR WIRELESS COMMUNICATIONS SYSTEMS

(76) Inventor: Hsu-Hsiang Tseng, Tao-Yuan Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/707,586

(22) Filed: Dec. 22, 2003

(30) Foreign Application Priority Data
Nov. 20, 2003 (TW) 092132552

(51) Int. Cl. H04L 5/12

(52) U.S. Cl. 375/261

(57) ABSTRACT

A de-mapping method for wireless communications systems transforms an I signal and a Q signal transformed from wireless signals received by a receiver in a wireless communications system into a plurality of sequentially ordered I and Q weighting values respectively. The first I and the first Q weighting values are set to be values of the I and Q signals respectively, and following I and Q weighting values are set to be products of bit signs corresponding to preceding respective I and Q weighting values and differences between the preceding I and Q weighting values and a threshold value corresponding to the preceding I and Q weighting values by determining signs of the preceding I and Q weighting values.

### BACKGROUND OF INVENTION

1. Field of the Invention

The present invention relates to a wireless communications system, and more particularly, to a soft decision de-mapping method for transforming an I/Q signal of a wireless communications system into a plurality of I/Q weighting values.

2. Description of the Prior Art

In recent years, due to the explosive progress in communications technology, a variety of channel encoding/decoding and modulating/demodulating methods have been introduced, and therefore data in a wireless communications system can be transmitted more quickly and correctly than ever before.

Please refer to FIG. 1, which is a function block diagram of a communications system 10 according to the prior art. The communications system 10 comprises a transmitter 12 and a receiver 14. The transmitter 12 comprises an encoder 16, a mapping device 18, a modulator 20, and a transmitting module 22. The receiver 14 comprises a receiving module 24, a demodulator 26, a de-mapping device 28, and a decoder 30.

How the communications system 10 transmits data is described briefly as follows: The encoder 16 of the transmitter 12 transforms data ready to be transmitted into bit string data with a specific data-transforming mechanism, such as an interleaving mechanism, a forward error correction (FEC) mechanism, or a cyclic redundant correction (CRC) mechanism, etc. Then the mapping device 18 maps the bit string data onto a predetermined constellation diagram corresponding to a predetermined modulation mechanism, such as BPSK, QPSK, 16 QAM, or 64 QAM, and transforms the bit string data into an integral I/Q signal. After the mapping device 18 generates the I/Q signal, the modulator 20 executes an inverse fast Fourier transform (IFFT) to transform the I/Q signal corresponding to a frequency domain into a packet-formed baseband signal corresponding to a time domain and transmits the baseband signal as well as a guard band to the transmitting module 22. Lastly, the transmitting module 22 transforms the baseband signal with the guard band into an intermediate frequency signal and into a radio frequency signal sequentially and emits the radio frequency signal.

How the communications system 10 receives data is similar to those data-transmitting procedures described above. The receiving module 24 of the receiver 14 receives the radio frequency signal transmitted from the transmitting module 22 of the transmitter 12 and recovers the radio frequency signal into a baseband signal. The demodulator 26 rids the guard band involved in the baseband signal and executes a fast Fourier transform (FFT) to transform the baseband signal corresponding to the time domain into an I/Q signal corresponding to the frequency domain. The de-mapping device 28 de-maps the I/Q signal onto a constellation diagram the same as the constellation diagram applied in the transmitter 12 and generates a bit string data corresponding to the I/Q signal. Lastly, the decoder 30 transforms the bit string data into output data.

In theory, the I/Q signal generated by the receiver 14 should be two integers directing to a Gray code on a constellation diagram accurately. However, data in the transmitting and receiving procedures are inevitably interfered with unexpected noise so that the I/Q signal are not always two integral numbers and the I/Q signal therefore cannot be directed to a Gray code on a constellation diagram accurately. In result, the non-integer I/Q signal has to be further transformed into an integral I/Q signal to directly correspond to a Gray code by using other methods.

A so-called hard decision method is one of the most popular methods used to solve the above-mentioned problem. Please refer to FIG. 2, which is a 64 QAM constellation diagram according to the prior art, wherein the abscissa represents an I signal and the ordinate represents a Q signal. The constellation diagram includes 64 (2⁽³⁺³⁾) constellation points, each of the constellation points corresponding to a Gray code of six bits, the former three bits representing an I signal of an I/Q signal and the latter three bits representing a Q signal of the I/Q signal. The communications system 10 is assumed to apply the 64 QAM modulation mechanism. The hard decision method maps both a first constellation point (I₁, Q₁) and a second constellation point (I₂, Q₂) onto an identical Gray code corresponding to a dash-lined area where the first and the second constellation points are located within, despite that data respectively represented by the first and the second constellation points are different from each other.

In an environment full of noise, a third constellation point (I₁, Q₁″) located at a deviated position neighboring an edge of the dashed-lined area with a center Gray code (101111), a Gray code that the second constellation point (I₂, Q₂) directs, is probably deviated from an initial noiseless position, for example (4.7, 1.9), within the dashed-lined area with a center Gray code (101110). Such a position deviation results that the de-mapping device 28 probably generates a wrong bit string data, that is 101111, instead of a correct bit string data, that is 101110, a Gray code the point (4.7, 1.9) should have been directed to, and that the coding gain is therefore reduced. Furthermore, because the wrong bit string data cannot be amended accurately, the bit error ratio is therefore increased.

A soft decision method disclosed by Rajiv Vijayan et al. in a U.S. Pat. No. 6,282,168 solves the problem due to the insufficient resolution (the wrong and the correct constellation points map to an identical Gray code) by calculating a plurality of weighting values corresponding to an I/Q signal. Rajiv Vijayan et al. calculate a first weighting value difference between a first left weighting value sum of 32 first left distances respectively from an I/Q signal on a 64 QAM constellation diagram, for example, to each of the 32 constellation points left of a central line of the constellation diagram, and a first right weighting value sum of 32 first right distances respectively from the I/Q signal to each of the 32 constellation points right of the central line first, and calculate a first I/Q weighting values corresponding to the I/Q signal. Rajiv Vijayan et al. then calculate a second I/Q weighting value corresponding to the I/Q signal by determining the sign of the first I/Q weighting value. In detail, if the first weighting value is positive, Rajiv Vijayan et al. calculate a second weighting value difference between a second left weighting value sum of eight second left distances respectively from the I/Q signal to each of the eight constellation points left of a central line of the first quadrant of the constellation diagram, and a second right weighting value sum of eight right distances respectively from the I/Q signal to each of the eight constellation points right of the central line of the first quadrant, and calculate the second I/Q weighting value corresponding to the I/Q signal. If the first weighting value is negative, Rajiv Vijayan et al. calculate a second weighting value difference between a second left weighting value sum of eight second left distances respectively from the I/Q signal to each of the eight constellation points left of a central line of the third quadrant of the constellation diagram and, a second right weighting value sum of eight right distances respectively from the I/Q signal to each of the eight constellation points right of the central line of the third quadrant, and calculate the second I/Q weighting value corresponding to the I/Q signal. Rajiv Vijayan et al. calculate all of the I/Q weighting values corresponding to the I/Q signal according to the above-described procedures. Such a soft decision method for calculating the I/Q weighting values corresponding to the I/Q signal is indeed resistant to the error (two individual constellation points mapping to an identical Gray code) encountered in the hard decision method. However, the lengthy soft decision method calculates the I/Q weighting values as accurate as it can at the expense of efficiency.

### SUMMARY OF INVENTION

It is therefore a primary objective of the claimed invention to provide a soft decision de-mapping method for a wireless communications system, the soft decision method capable of reducing the bit error rate (BER), and of increasing the efficiency of the wireless communications system.

According to the claimed invention, the method is applied to a wireless communications system. The communications system comprises a transmitter and a receiver, the transmitter comprising an encoder, a mapping device, a signal modulator and a transmitting module, the receiver comprising a receiving module, a signal demodulator, a de-mapping device and a decoder. The method comprises the following steps: (a) encoding at least a bit string with the encoder; (b) mapping the encoded bit string into a first gray-code-typed I signal and a first gray-code-typed Q signal with the mapping device; (c) transforming the first gray-code-typed I and Q signals into a first modulated signal with the signal modulator; (d) transforming the first modulated signal into an RF signal and transmitting the RF signal with the transmitting module; (e) receiving the RF signal with the receiving module; (f) transforming the RF signal into a second modulated signal and demodulating the second modulated signal into I signal and a second Q signal with the signal demodulator; (g) setting an initial I weighting value to be equal to (the second I signal)*(a first bit sign a first threshold value) with the de-mapping device; (h) setting a following I weighting value to be a product of a bit sign corresponding to an I weighting value preceding the following I weighting value and a difference between the preceding I weighting value and a threshold value corresponding to the preceding I weighting value according to a sign of the preceding I weighting value with the de-mapping device;(i) setting an initial Q weighting value to be equal to (the second Q signal)*(a second bit sign a second threshold value) with the de-mapping device; (j) setting a following Q weighting value to be a product of a bit sign corresponding to a Q weighting value preceding the following Q weighting value and a difference between the preceding Q weighting value and a threshold value corresponding to the preceding Q weighting value according to a sign of the preceding Q weighting value with the de-mapping device; and (k) quantizing all of the I and Q weighting values and transferring all of the quantized I and Q weighting values to the decoder.

It is an advantage of the claimed invention that the soft decision de-mapping method is capable of calculating a plurality of weighting values of an I/Q signal and of overcoming the drawback of insufficient resolution of the hard decision method. Moreover, the weighting value calculation steps of the claimed invention are far fewer than those in the prior art soft decision method.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a function block diagram of a communications system 10 according to the prior art.

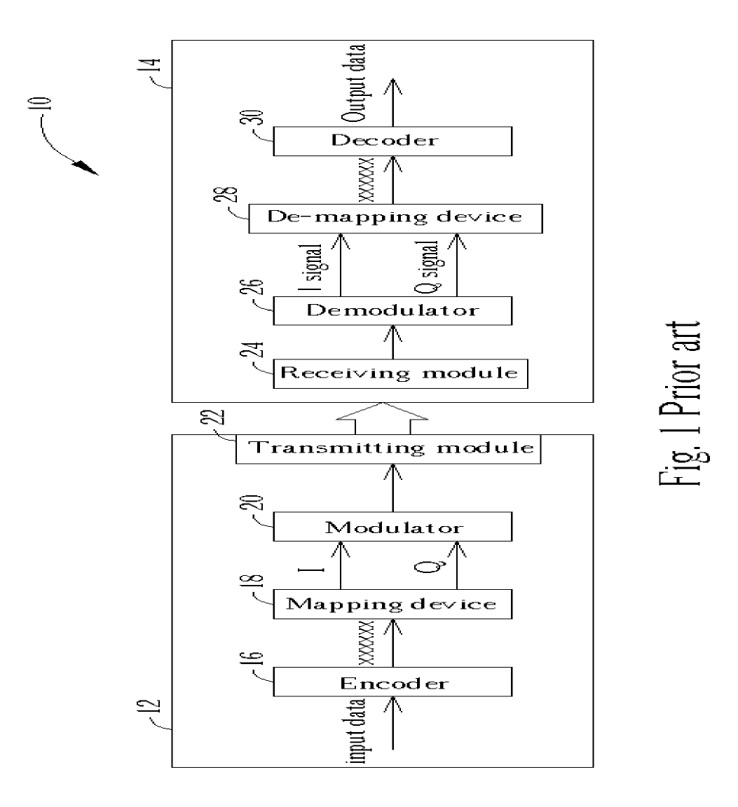

FIG. 2 is a 64 QAM constellation diagram according to the prior art.

FIG. 3 is a function block diagram of a communications system of the preferred embodiment according to the present invention.

FIG. 4 is a flowchart of a method of the preferred embodiment according to the present invention.

### DETAILED DESCRIPTION

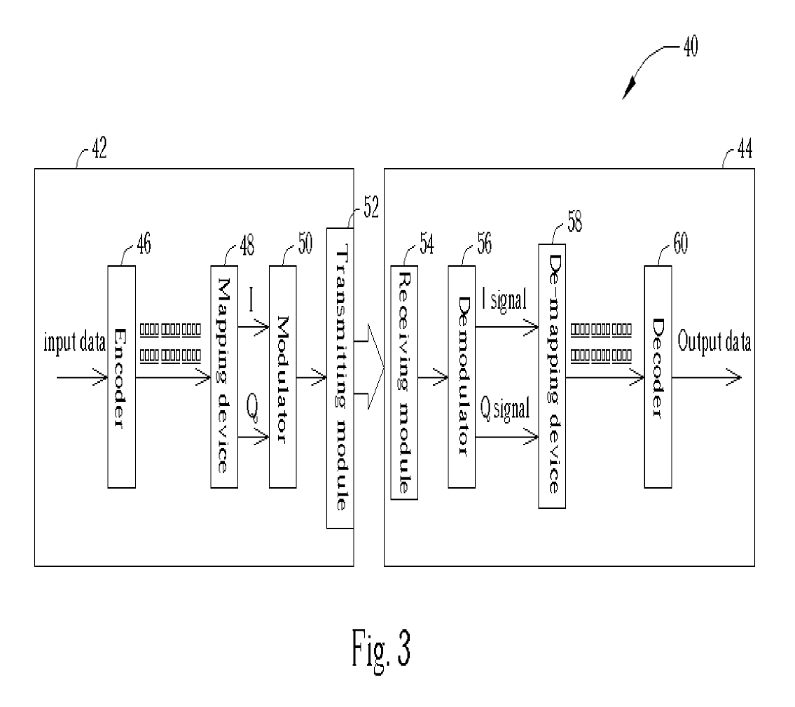

Please refer to FIG. 3, which is a function block diagram of a communications system 40 of the preferred embodiment according to the present invention. The communications system 40 comprises a transmitter 42 and a receiver 44. The transmitter 42 comprises an encoder 46, a mapping device 48, a modulator 50, and a transmitting module 52. The receiver 44 comprises a receiving module 54, a demodulator 56, a de-mapping device 58, and a decoder 60. Each of the components in the communications system 40 has a structure and a function the same as the corresponding component of the communications system 10, and further description is hereby omitted.

In the preferred embodiment of the present invention, the de-mapping device 58 of the receiver 44 de-maps an I/Q signal onto three sets of numbers (S_{b0} S_{b1} S_{b2} ,S_{b3} S_{b4} S_{b5}) illustrated in a position between the de-mapping device 58 and the decoder 60, each of the numbers having a weighting value of five bits. Since the soft decision method of the present invention has an I weighting values calculation procedure similar to a Q weighting values calculation procedure, only the I weighting values calculation procedure is described hereafter.

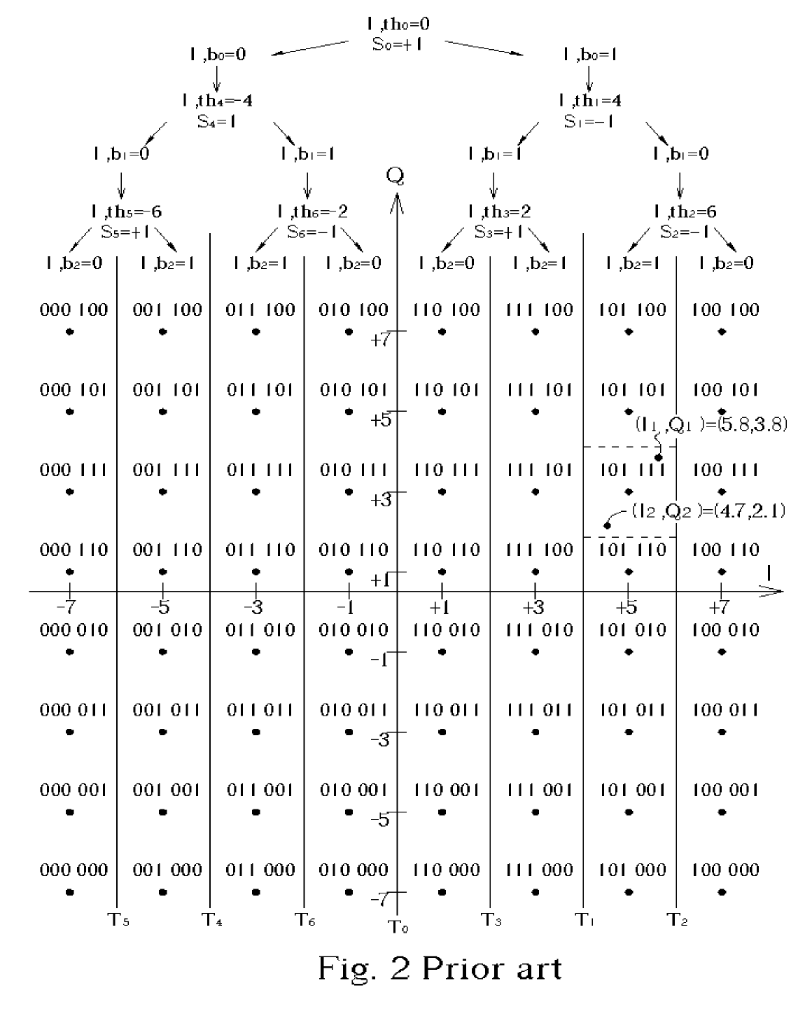

The Gray code has the specific characteristic of the Hamming distance being equal to one and is therefore widely applied to a variety of wireless communications systems, including the communications system 40 of the present invention. Please refer to FIG. 2 again. The constellation diagram is divided into eight equal-sized strip areas by seven threshold lines T₀-T₆, having seven corresponding bit signs S₀-S₆ of 1, −1, −1, 1, 1, 1 and −1 and seven corresponding threshold values th₀-th₆ of 0, 4, 6, 2, −4, −6 and −2. How the bit signs and the threshold values of the threshold lines T₀-T₆ are set is described briefly as follows: The Gray code of each of the I signals left to the threshold line T₀ has a first bit b₀ equal to zero, while the Gray code of each of the I signal right to the threshold line T₀ has a first bit b₀ equal to one, thus setting the bit sign S₀ of the threshold line T₁ as one and the threshold value th₀ of the threshold line T₀ as zero; According to a plane right of the threshold line T₀, the Gray code of each of the I signals left of the threshold line T₁ has a second bit b₁ equal to one, while the Gray code of each of the I signal right of the threshold line T₁ has a second bit b₁ equal to zero, thus setting the bit sign S₁ of the threshold line T₁ as minus one and the threshold value th₁ of the threshold line T₁ as four; According to a plane right of the threshold line T₁, the Gray code of each of the I signals left of the threshold line T₂ has a third bit b₂ equal to one, while the Gray code of each of the I signal right of the threshold line T₂ has a third bit b₂ equal to zero, thus setting the bit sign S₂ of the threshold line T₂ as minus one and the threshold value th₂ of the threshold line T₂ as six; According to a plane left of the threshold line T₁, the Gray code of each of the I signals left of the threshold line T₃ has a third bit b₂ equal to zero, while the Gray code of each of the I signal right to the threshold line T₃ has a third bit b₂ equal to one, thus setting the bit sign S₃ of the threshold line T₃ as one and the threshold value th₃ of the threshold line T₃ as two, and so on.

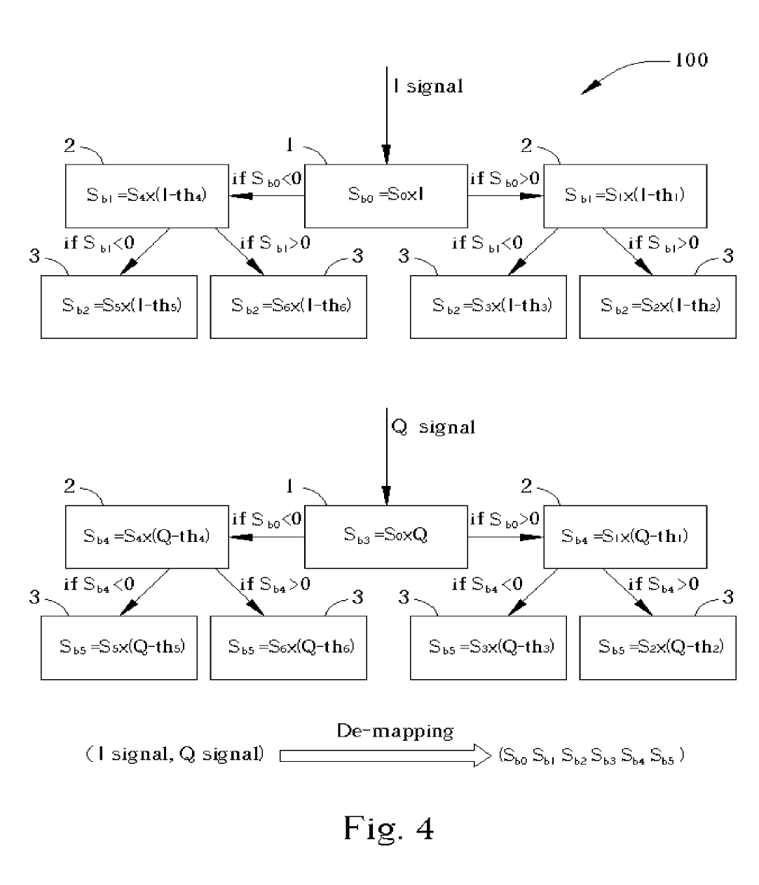

The method of the present invention de-maps an I/Q signal into (S_{b0} S_{b1} S_{b2}, S_{b3} S_{b4} S_{b 5}). How the method de-maps an I signal of an I/Q signal into (S_{b0} S_{b1} S_{b2}) is described in FIG. 4, which is a flowchart of the method described in the following steps: 1)set an initial weighting value S_{b0} of the I signal as the I signal;2)if the initial weighting value S_{b0} is positive, calculate a second weighting value S_{b1} of the I signal according to the bit sign S₁ and the threshold value th₁ of the threshold line T₁, that is S_{b1}=S₁*(the I signal−th₁); If the initial weighting value S_{b0} is negative, calculate a second weighting value S_{b1} of the I signal according to the bit sign S₄ and the threshold value th₄ of the threshold line T₄, that is S_{b1}=S₄*(the I signal th₄); and 3)if both the initial weighting value S_{b0} and the second weighting value S_{b1} are positive, calculate a final weighting value S_{b2} according to the bit sign S₂ and the threshold value th₂ of the threshold line T₂, that is S_{b2}=S₂*(the I signal th₂); if the initial weighting value S_{b0} is positive while the second weighting value S_{b1} is negative, calculate a final weighting value S_{b2} according to the bit sign S₃ and the threshold value th of the threshold line T₃, that is S_{b2}=S₃*(the I signal th₃); if the initial weighting value S_{b0} is negative while the second weighting value S_{b1} is positive, calculate a final weighting value S_{b2} according to the bit sign S₆ and the threshold value th₆ of the threshold line T₆, that is S_{b2}=S₆*(the I signal th₆); if both the initial weighting value S_{b0} and the second weighting value S_{b1} are negative, calculate a final weighting value S_{b2} according to the bit sign S₅ and the threshold value th₅ of the threshold line T₅, that is S_{b2}=S₅*(the I signal th₅).

As mentioned above, an initial weighting value S_{b3}, a second weighting value S_{b4}, and a final weighting value S_{b5} of a Q signal of the I/Q signal can also be calculated following the procedures described in FIG. 4.

As an example, how the method calculates the weighting values of an I/Q signal (4.7, −2.1) is described step by step according to the procedures shown in FIG. 4.
1)set an initial weighting value S_{b0} corresponding to an I signal of the I/Q signal (4.7, −2.1) as 4.7;
2)since the initial weighting value S_{b0} corresponding to the I signal of 4.7 is positive, a second weighting value S_{b1} corresponding to the I signal of the I/Q signal (4.7, −2.1) is S_{b1}=S₁*(I−th₁)=−1*(4.7−4)=−0.7;
3)since the second weighting value S_{b1} of −0.7 corresponding to the I signal is negative, a final weighting value S_{b2} corresponding to the I signal of the I/Q signal (4.7, −2.1) is S_{b2}=S₃*(the I signal−th₃)=1*(4.7 −2)
4)set an initial weighting value S_{b3} corresponding to a Q signal of the I/Q signal (4.7, −2.1) as 2.1;
5)since the initial weighting value S_{b3} corresponding to the Q signal of 2.1 is negative, a second weighting value corresponding to the Q signal S_{b4} of the I/Q signal (4.7, −2.1) is S_{b4}=S₄*(the Q signal−th₄)=₁*(−2.1−(−4))=1.9; and
6)since the second weighting value S_{b4} corresponding to the Q signal of 1.9 is positive, a final weighting value S_{b5} corresponding to the Q signal of the I/Q signal (4.7, −2.1) is S_{b5}=S₆*(the Q signal−th₆)=−1*(−2.1−(−2))=0.1.

In summary, the weighting values corresponding to the I/Q signal (4.7, −2.1) are (4.7, −0.7, 2.7, −2.1, 1.9, 0.1). The de-mapping device 58 can further quantize (S_{b0} S_{b1} S_{b2}, S_{b3} S_{b4} S_{b5}) into quantized data five bits for each number and transfer the quantized data to the decoder 60. The quantizing process is well known to those skilled in the art, and further description is hereby omitted.

Although the 64 QAM is used as an example to demonstrate the method of the present invention, other orthogonal modulation mechanisms, such as BPSK, QPSK, 16 QAM, 256 QAM, or even 1024 QAM are also applicable to the method.

In contrast to the hard decision method, the present invention can provide a soft decision method to calculate a plurality of weighting values of an I/Q signal and to overcome the drawback of insufficient resolution of the hard decision method. Additionally, the weighting value calculation steps of the present invention are far fewer than in the prior art soft decision method.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

1. A de-mapping method for a wireless communications system, the communications system comprising a transmitter and a receiver, the transmitter comprising an encoder, a mapping device, a signal modulator and a transmitting module, the receiver comprising a receiving module, a signal demodulator, a de-mapping device and a decoder, and the method comprising the following steps:
(a)encoding at least a bit string with the encoder;
(b)mapping the encoded bit string into a first gray-code-typed I signal and a first gray-code-typed Q signal with the mapping device;
(c)transforming the first gray-code-typed I and Q signals into a first modulated signal with the signal modulator;
(d)transforming the first modulated signal into an RF signal and transmitting the RF signal with the transmitting module;
(e)receiving the RF signal with the receiving module;
(f)transforming the RF signal into a second modulated signal and demodulating the second modulated signal into I signal and a second Q signal with the signal de-modulator;
(g)setting an initial I weighting value to be equal to (the second I signal)*(a first bit sign a first threshold value) with the de-mapping device;
(h)setting a following I weighting value to be a product of a bit sign corresponding to an I weighting value preceding the following I weighting value and a difference between the preceding I weighting value and a threshold value corresponding to the preceding I weighting value according to a sign of the preceding I weighting value with the de-mapping device;
(i)setting an initial Q weighting value to be equal to (the second Q signal)*(a second bit sign a second threshold value) with the de-mapping device;
(j)setting a following Q weighting value to be a product of a bit sign corresponding to a Q weighting value preceding the following Q weighting value and a difference between the preceding Q weighting value and a threshold value corresponding to the preceding Q weighting value according to a sign of the preceding Q weighting value with the de-mapping device; and
(k)quantizing all of the I and Q weighting values and transferring all of the quantized I and Q weighting values to the decoder.

2. The method of claim 1, wherein the first bit sign in step (g) is equal to 1 and the first threshold value is equal to zero.

3. The method of claim 1, wherein the de-mapping device in step (h) determines signs of all I weighting values preceding the following I weighting value and sets the following I weighting value thereafter.

4. The method of claim 1, wherein the second bit sign in step (i) is equal to 1 and the second threshold value is equal to zero.

5. The method of claim 1, wherein the de-mapping device in step (j) determines signs of all Q weighting values preceding the following Q weighting value and sets the following Q weighting value thereafter.
